(19) United States
(12) Patent Application Publication
(10) Pub. No.: US 2004/0057071 A1
(43) Pub. Date: Mar. 25, 2004

(54) Multi-function peripherals

(76) Inventors: Yi-Liang Lin, Taipei (TW); Cheng-Hui Yu, Hualien (TW); Min Chao, Taipei (TW)

Correspondence Address: BIRCH STEWART KOLASCH & BIRCH, PO BOX 747, FALLS CHURCH, VA, 22040-0747, US

(21) Appl. No.: 10/253,580

(22) Filed: Sep. 25, 2002

(51) Int. Cl. G06K 1/00; H04N 1/04

(52) U.S. Cl. 358/1.15; 358/474

(57) ABSTRACT

A multi-function peripheral is able to process a plurality of functions such as printing, copying and scanning, and enables a power output device to selectively drive two different devices depending on required functions. The invention provides a switching mechanism, which can change delivery of power to the first device or the second device so that either the first device or the second device may be selected to process the desired function. The multi-function peripheral thus constructed does not need one dedicated power output device to match one working device and can reduce the number of power output devices required.

### FIELD OF THE INVENTION

The invention relates to multi-function peripherals adopted for use in electronic equipment that has multiple functions, and particularly to electronic equipment that requires multiple power output devices to drive multiple corresponding working devices.

### BACKGROUND OF THE INVENTION

Office machines such as copiers, printers, facsimile machines and scanners have become indispensable information equipment in the office environment. All business and administrative tasks are closely tied to these machines. Each machine occupies a site. Adding it all together, they take a great deal of space and become a great burden to work environments. In addition, each machine has different functional properties, and the utilization rates for these single function office machines are also different. Some machines are not heavily used. But in order to meet the requirements of business, they still have to be bought and installed.

In order to remedy the problems set forth above, Multi-Function Peripherals (MFPs) have been developed and introduced. These MFPs integrate the functions of copying, printing, FAX, scanning, etc. Users need to procure only one set of MFP to process multiple office tasks, saving a lot of space and cost. These MFPs often provide a simple operation interface and become an All-in-one device.

Refer to FIGS. 1A and 1B for a conventional MFP. A conventional MFP, depending on different brands and machine types, integrates various functions, such as copying, printing, facsimile, scanning, etc. These functions are processed by different working devices. Take FIGS. 1A and 1B for instance. The MFP has a scanning device located on its upper side to process scanning operations. Coupling with microprocessor settings and matched communication lines, FAX operation may be processed after document scanning is completed. Inside the machine frame, there is also an inkjet working device. On one side of the machine frame there is a paper feeding device which is coupled with the inject working device to process document printing. This MFP should include at least a scanning device, an inkjet device and a paper feeding device. The scanning device includes a reciprocal Charge-Coupled Device (CCD), a transmission belt coupled with the CCD, and a driving motor coupled with the transmission belt to provide rotation power. The inkjet device includes a carrier, which carries an ink cartridge and can be moved reciprocally, a transmission belt coupled with the carrier and a driving motor coupled with the transmission belt to provide rotation power. The paper feeding device includes a rotary paper feeding barrel, a transmission gear set engaging with a paper feeding shaft, and a driving motor engaged with the transmission gear set to provide the rotation power.

In the aforesaid MFP, the devices and the driving motor are coupled in a one-on-one fashion. The rotation power required by each device is provided by one driving motor. Such a design merely puts a scanner and an inkjet printer in a machine frame. While the electronic circuits are integrated, in terms of the mechanism, each device still operates independently. Hence they are not truly integrated. The components required by each working device remain the same. The size of the machine frame after the multiple functions are integrated is not substantially reduced. The driving motors still take a significant portion of the cost and occupy a great amount of space in the machine frame.

### SUMMARY OF THE INVENTION

The primary object of the invention is to provide a multi-function peripheral (MFP) to integrate a plurality of working devices in a machine frame and employ one driving motor to selectively drive two working devices to reduce the cost and size of the MFP.

The MFP of the invention integrates a plurality of devices, a plurality of transmission mechanisms that correspond to the devices, more than one power output device and one switching mechanism. Each working device includes a movement mechanism connected to a corresponding transmission mechanism. The switching mechanism and the power output device bridge two transmission mechanisms. Through the switching mechanism, the output power of the power output device may be selectively transmitted to one of the working devices to process desired operations.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A and 1B are schematic views of the construction of conventional MFPs.

FIGS. 2A and 2B are schematic views of a first embodiment of the invention.

FIG. 3 is a perspective view of the first embodiment of the invention.

FIG. 4A is a fragmentary enlarged view of the first embodiment of the invention.

FIGS. 4B and 4C are schematic views of the first embodiment in operation.

FIGS. 5A and 5b are schematic views of a second embodiment of the invention.

FIG. 6A is a fragmentary enlarged view of the second embodiment of the invention.

FIGS. 6B and 6C are schematic views of the second embodiment in operation.

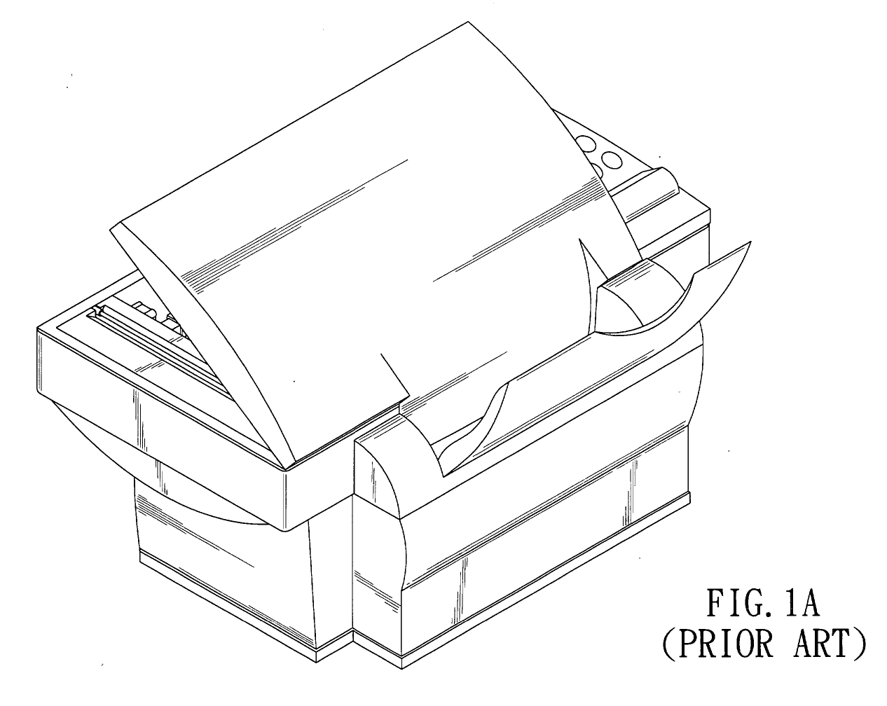

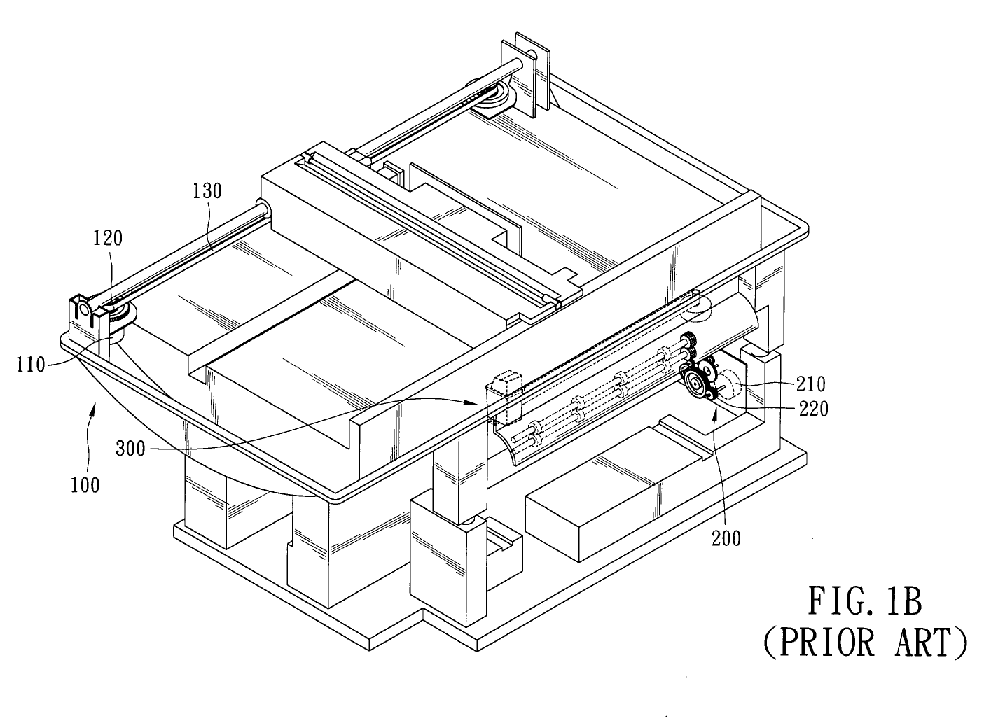

### DESCRIPTION OF THE PREFERRED EMBODIMENTS

The invention aims at providing a multi-function peripheral (MFP) to integrate office business functions such as copying, printing, facsimile and scanning. The invention includes at least a scanning device, an inkjet device and a paper feeding device. The primary object of the invention is to use one driving motor to selectively actuate two devices (such as the scanning device and the paper feeding device). The following are embodiments of the invention to achieve the foregoing object.

First Embodiment.

The Technical Approach Adopted in the First Embodiment:

A switching mechanism is employed to move the driving motor reciprocally to selectively connect to two devices.

The Practical Technique and Method for the First Embodiment:

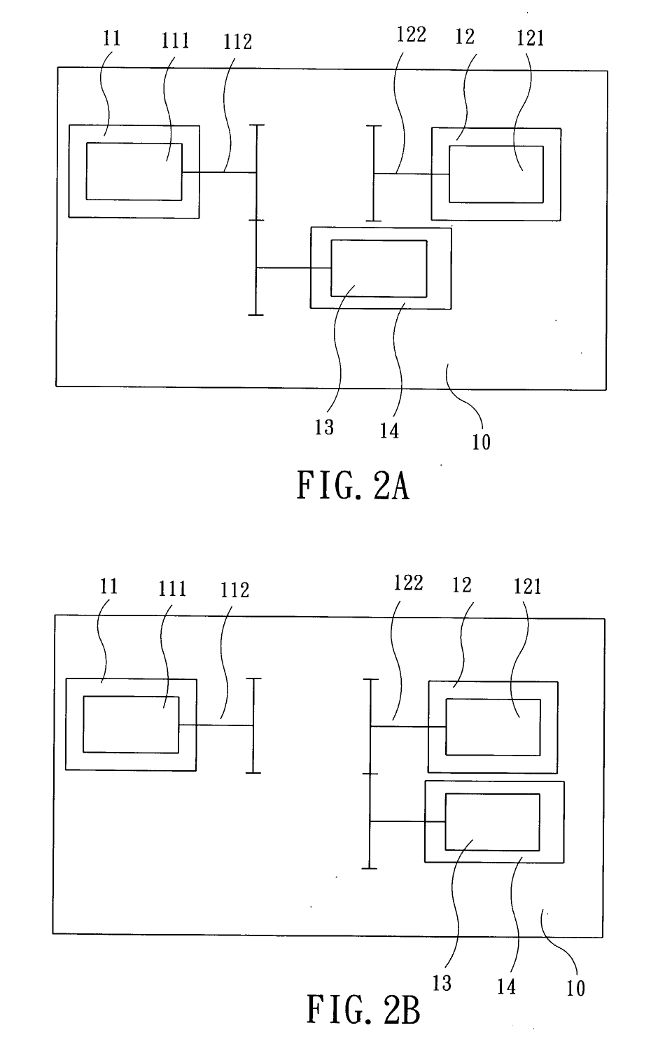

Referring to FIGS. 2A and 2B, the MFP 10 of the invention consists of a first working device 11, a second working device 12, a power output device 13 and a switching mechanism 14. The first working device 11 includes a first movement mechanism 111 and a first transmission mechanism 112 connected to the first movement mechanism 111. The second working device 12 includes a second movement mechanism 121 and a second transmission mechanism 122 connected to the second movement mechanism 121. The switching mechanism 14 is movable reciprocally between the first transmission mechanism 112 and the second transmission mechanism 122, and has a first position and a second position between the first transmission mechanism 112 and the second transmission mechanism 122. The power output device 13 is located on the switching mechanism 14. When the switching mechanism 14 is located at the first position, the output shaft 131 of the power output device 13 corresponds and connects to the first transmission mechanism 112. When the switching mechanism 14 is located at the second position, the output shaft 131 of the power output device 13 corresponds and connects to the second transmission mechanism 122. As mentioned above, when a user wants to use the first device 11, s/he must move the switching mechanism 14 to the first position. The output shaft 131 of the power output device 13 then connects to the first transmission mechanism 112 of the first working device 11, and the output power of the power output device 13 is transmitted through the first transmission mechanism 112 to the first movement mechanism 111 to drive the first movement mechanism 111. When the user wants to use the second device 12, s/he must move the switching mechanism 14 to the second position. The output shaft 131 of the power output device 13 then connects to the second transmission mechanism 122 of the second working device 12, and the output power of the power output device 13 is transmitted through the second transmission mechanism 122 to the second movement mechanism 121 to drive the second movement mechanism 121.

Thus, by means of one power output device 13, the first device 11 or the second device 12 may be driven. The first and the second transmission mechanisms 112 and 122 may be gear sets or transmission belt sets to drive the transmission mechanisms 112 and 122 to rotate or move reciprocally.

Practical Approaches for Implementing the First Embodiment:

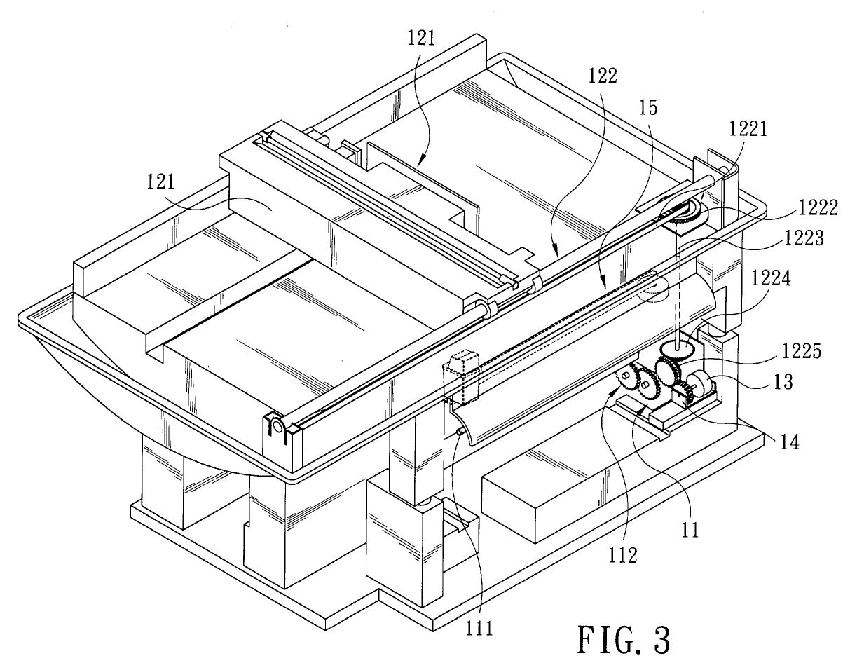

Referring to FIG. 3, the MFP 10 of the invention includes a first device 11, a second device 12 and a third device 15 to respectively process functions of paper feeding, scanning and inkjet printing. The first device 11 and the second device 12 share one power output device 13. The third device 15 individually uses one power output device 13. The power output device 13 is a driving motor, and preferably a step motor when adopted on the MFP of the invention.

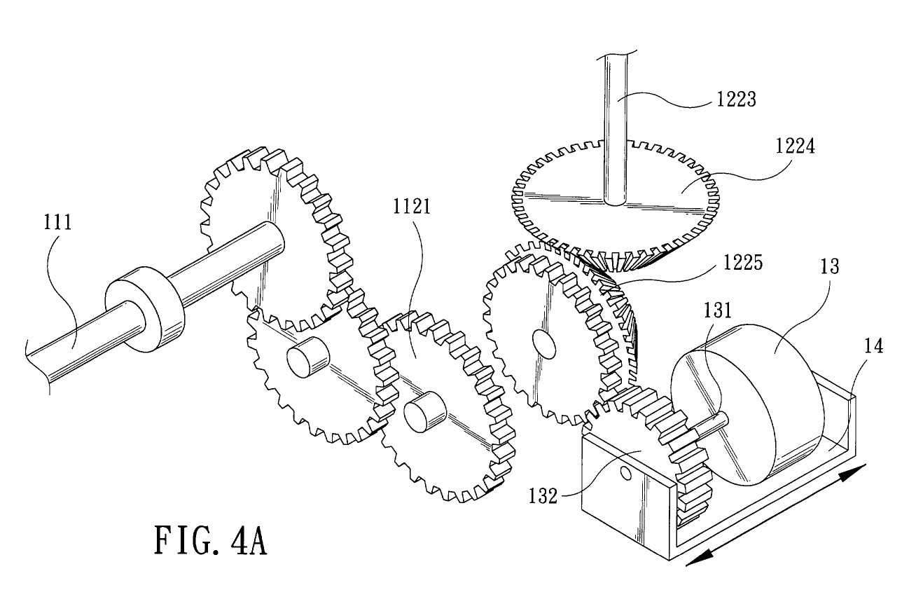

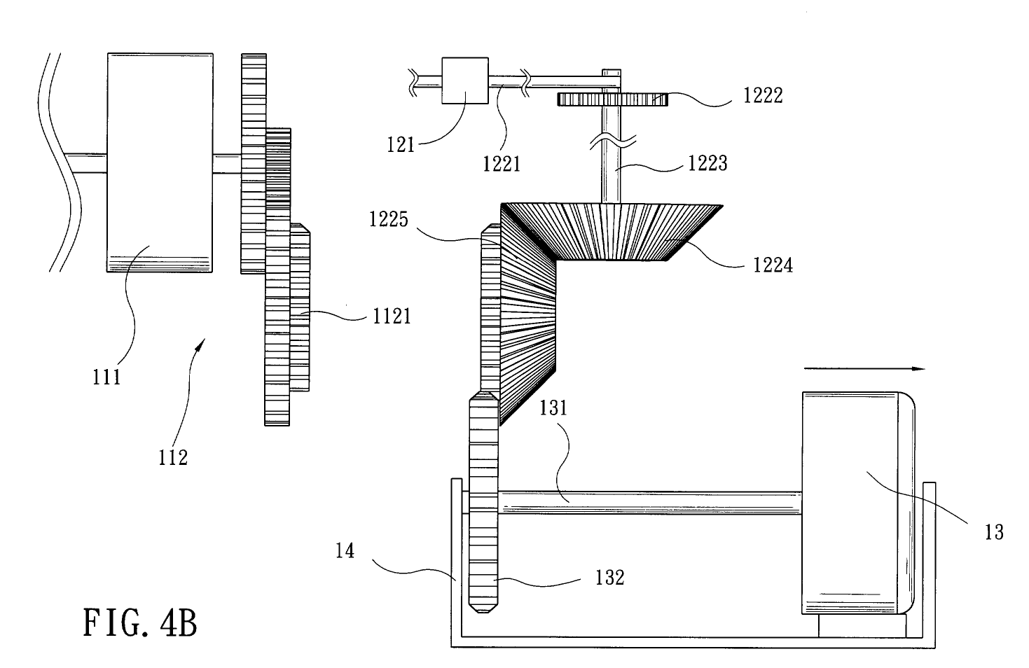

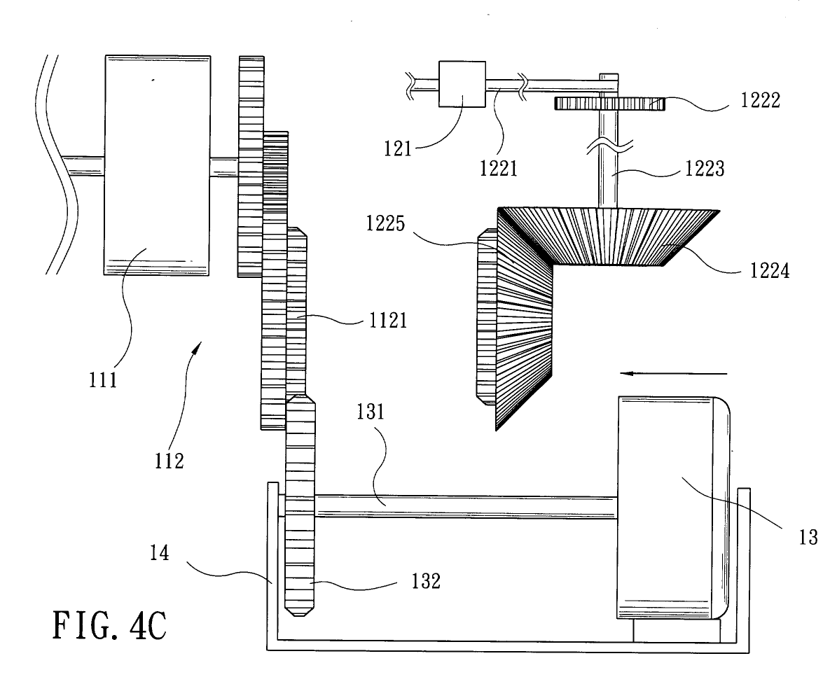

Referring to FIGS. 4A, 4B and 4C, the first device 11 is a paper feeding device, and the first movement mechanism 111 is a paper feeding barrel. The first movement mechanism 111 has to rotate in one direction in a step moving manner to move paper individually from a paper cartridge (not shown in the drawings) to a corresponding location in the third device 15 (inkjet device) for printing operations, then move the printed paper leaving the paper exit (not shown in the drawings). The first transmission mechanism 112 for transmitting the rotation power to the first movement mechanism 111 is a gear set. The gear set engages with the first movement mechanism and has a connection gear 1121 engaging with a power source. The second device 12 is a scanning device. The second movement mechanism 121 is a CCD. The second movement mechanism 122 moves reciprocally to attain a parallel displacement so that the scanning operation may be done for documents located on the scanning platform (not shown in the drawings). The second transmission mechanism 122 includes a transmission belt 1221 coupled with a gear set. The second movement mechanism 121 is located on the transmission belt 1221, which has one end coupling with a gear 1222. The gear 1222 has a gear stem 1223 extended downwards. The other end of the gear stem 1223 is attached to a bevel gear 1224, which in turn engages with a connection bevel gear 1225. The connection bevel gear 1225 connects to a power source. The connection bevel gear 1225 is spaced from the connection gear 1121 at a selected distance.

The switching mechanism 14 is a carrier in the MFP 10, and may be moved to the first position and the second position. The power output device 13 is a driving motor anchored on the switching mechanism 14. The power output device 13 has an output shaft 131 attached to a main gear 132. When the switching mechanism 14 is moved to the first position, the main gear 132 of the power output device 13 engages with the connection gear 1121. When the switching mechanism 14 is moved to the second position, the main gear 132 of the power output device 13 engages with the connection bevel gear 1125. The switching mechanism 14 may be moved by an external force (such as through a push bar installed on the switching device 14 that can be moved by users) between the first position and the second position. A retaining pin or tenon (not shown in the drawings) may be used to border and anchor the first position or the second position. Movement of the switching mechanism 14 may also be driven by the movement displacement of the third device 15.

Referring to FIGS. 4B and 4C, when using the first device 11, move the switching mechanism 14 to the first position. The main gear 132 of the power output device 13 engages with the connection gear 1121 of the first device 11. The output power of the power output device 13 is transmitted through the output shaft 131, the main gear 132, the connection gear 1121 and the gear set to the first movement mechanism 111. The first movement mechanism 111 rotates in a step moving manner to complete the paper feeding operation. When using the second device 12, move the switching mechanism 14 to the second position. The main gear 132 of the power output device 13 engages with the bevel connection gear 1225 of the second device 12. The output power of the power output device 13 is transmitted through the output shaft 131, the main gear 132, the bevel connection gear 1225, the bevel gear 1224, the gear stem 1223, the gear 1222, and the transmission belt 1221 to the second movement mechanism 121. Thus the second movement mechanism 121 may be moved reciprocally to complete the scanning operation.

Second Embodiment:

The Technical Approach Adopted in the Second Embodiment:

The driving motor is stationary, and the switching unit is employed to selectively transmit power to the second device.

The Practical Technique and Method for the Second Embodiment:

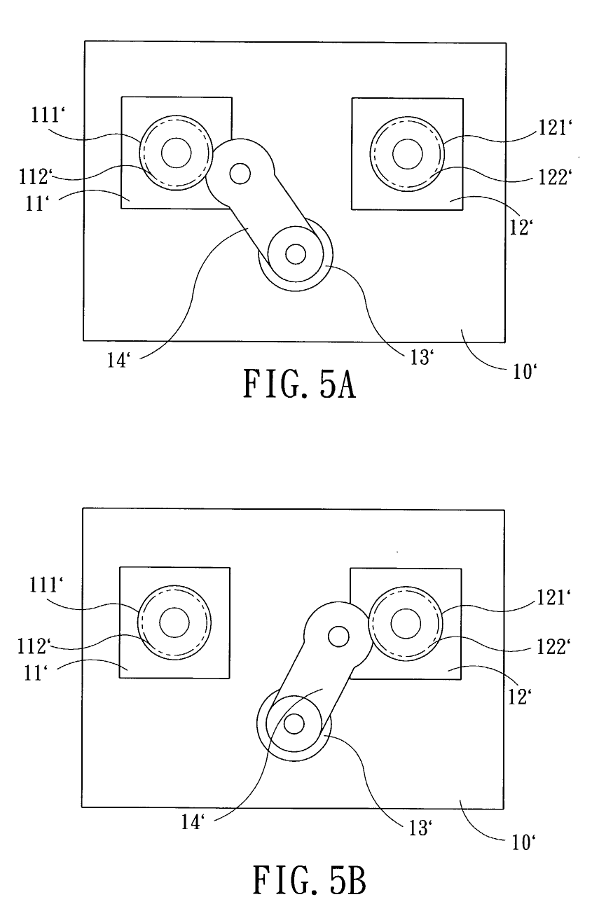

Referring to FIGS. 5A and 5B, the MFP 10′ of the invention consists of a first device 11′, a second device 12′, a power output device 13′ and a switching mechanism 14′. The first device 11′ includes a first movement mechanism 111′ and a first transmission mechanism 112′ connected to the first movement mechanism 111′. The working device 12′ includes a second movement mechanism 121′ and a second transmission mechanism 122′ connected to the second movement mechanism 121′. The switching mechanism 14′ is movable between the first transmission mechanism 112′ and the second transmission mechanism 122′, and has a first position and a second position between the first transmission mechanism 112′ and the second transmission mechanism 122′. The power output device 13′ connects to the switching mechanism 14′. When the switching mechanism 14′ is moved to the first position, the power output device 13′ transmits power to the switching mechanism 14′, and the switching mechanism 14′ connects to the first transmission mechanism 112′. When the switching mechanism 14′ is moved to the second position, the power output device 13′ transmits power to the switching mechanism 14′, and the switching mechanism 14′ connects to the second transmission mechanism 122′. As mentioned above, when using the first device 11, move the switching mechanism 14′ to the first position. The power output device 13′ delivers the output power through the switching mechanism 14′ to the first transmission mechanism 112′, then through the first transmission mechanism 112′ to the first movement mechanism 111′ so that the first movement mechanism 111′ functions as intended. When using the second device 12′, move the switching mechanism 14′ to the second position. The power output device 13′ delivers the output power through the switching mechanism 14′ to the second transmission mechanism 122′, then through the output second transmission mechanism 122′ to the second movement mechanism 121′ so that the second movement mechanism 121′ functions as intended.

Thus, while remaining stationary, the power output device 13′ may selectively drive the first device 11 ′ or the second device 12′ through the switching mechanism 14′.

Practical Approaches for Implementing the Second Embodiment:

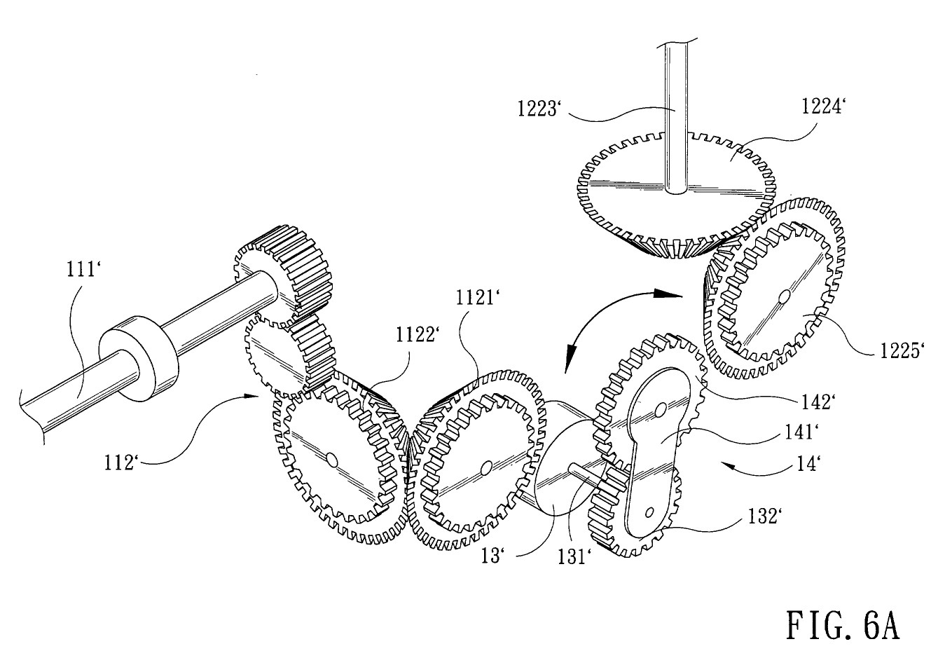

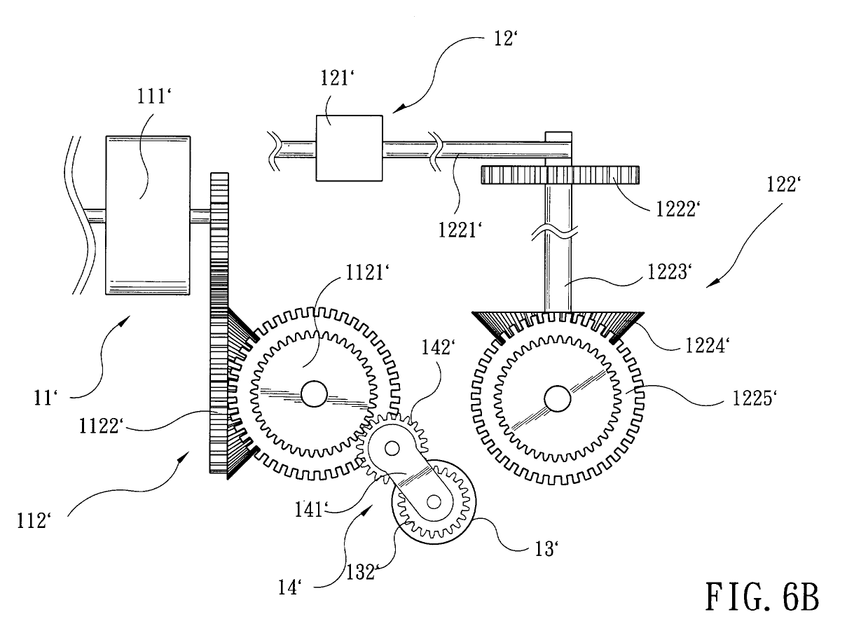

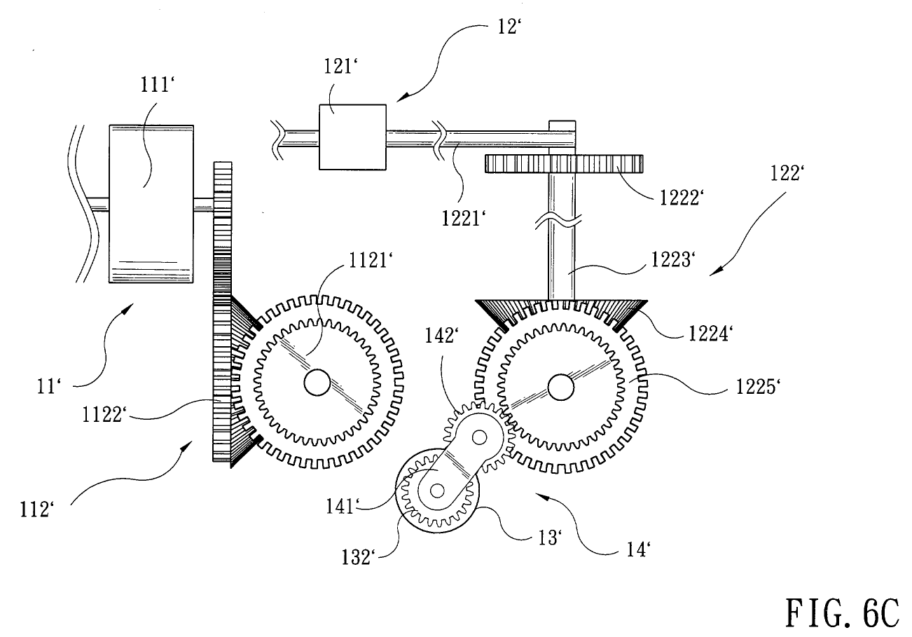

As shown in FIGS. 6A, 6B and 6C, the first device 11′, the first movement mechanism 11′, the second device 12′ and the second movement mechanism 121′ are the same as the first embodiment, thus details are omitted. The first transmission mechanism 112′ has a first connection bevel gear 1121′ connected to the power supply and a bevel gear 1122′ connected to a gear set. The second transmission mechanism 122′ has a second connection bevel gear 1225′ connected to the power supply. The first connection bevel gear 1121′ and the second connection bevel gear 1225′ are spaced from each other at a selected distance. The axes of the first and the second connection bevel gears 1121′ and 1225′ point in the same direction. The power output device 13′ is located between the first and the second connection bevel gears 1121′ and 1225′. The output shaft 131′ of the power output device 13′ couples with a main gear 132′. The switching mechanism 14′ includes a rocker arm 141′ and a driven gear 142′. The rocker arm 141′ has one end coupled with the output shaft 131′ upon which it rotates, and the other end pivotally engaged with the driven gear 142′. The driven gear 142′ engages with the main gear 132′. When the driven gear 142′ and the main gear 132′ are engaged, the rocker arm 141′ may be moved to the first position and the second position. At the first position, the driven gear 142′ engages with the first connection bevel gear 1121′. At the second position, the driven gear 142′ engages with the second connection bevel gear 1225′.

Referring to FIGS. 6B and 6C, when using the first device 11′, move the switching mechanism 14′ to the first position. The driven gear 142′ engages with the first connection bevel gear 1121 ′ of the first device 11′, and the output power of the power output device 13′ is transmitted through the output shaft 131′, the main gear 132′, the driven gear' 142′ of the switching mechanism 14′, the first connection bevel gear 1121′, the bevel gear 1122′ and the gear set to the first movement mechanism 111 ′. Hence the first movement mechanism 111 ′ rotates in a step moving manner to complete the paper feeding operation. When using the second device 12′, move the rocker arm 141′ of the switching mechanism 14′ to the second position. The driven gear 142′ engages with the second connection bevel gear 1225′ of the second device 12′, and the output power of the power output device 13′ is transmitted through the output shaft 131′, the main gear 132′, the driven gear 142′ of the switching mechanism 14′, the second connection bevel gear 1225′, the bevel gear 1224′, the gear stem 1223′, the gear 1222′, and the transmission belt 1221′ to the second movement mechanism 121′. Thus the second movement mechanism 121′ may be moved reciprocally to complete the scanning operation.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A multi-function peripheral consisting of a plurality of working devices for processing different operations and having a power output device to selectively drive two different work devices, comprising:
a first working device having a movable first movement mechanism and a first transmission mechanism connecting to the first movement mechanism;
a second working device having a movable second movement mechanism and a second transmission mechanism connecting to the second movement mechanism; and
a switching mechanism movably located between the first transmission mechanism and the second transmission mechanism, and being movable to a first position and a second position, the power output device being located on the switching mechanism;
wherein the power output device engages with the first transmission mechanism of the first working device when the switching mechanism is moved to the first position, and the power output device engages with the second transmission mechanism of the second working device when the switching mechanism is moved to the second position.

2. The multi-function peripheral of claim 1, wherein the power output device is a driving motor.

3. The multi-function peripheral of claim 1, wherein the power output device has an output shaft which couples with a main gear.

4. The multi-function peripheral of claim 1, wherein the first working device is a paper feeding device, the first movement mechanism is a paper feeding barrel, and the first transmission mechanism is a gear set.

5. The multi-function peripheral of claim 1, wherein the second working device is a scanning operation device, the second movement mechanism is charge-coupled device, and the second transmission mechanism is a transmission belt and a gear set.

6. The multi-function peripheral of claim 1, wherein the switching mechanism is a carrier.

7. A multi-function peripheral consisting of a plurality of working devices for processing different operations and having a power output device to selectively drive two different work devices, comprising:
a first working device having a movable first movement mechanism and a first transmission mechanism connecting to the first movement mechanism;
a second working device having a movable second movement mechanism and a second transmission mechanism connecting to the second movement mechanism; and
a switching mechanism movably located between the first transmission mechanism and the second transmission mechanism having a driven gear engaged with the power output device and a rocker arm movably coupled with the power output device, the rocker arm being movable to a first position and a second position;
wherein the driven gear engages with the first transmission mechanism of the first working device when the rocker arm is moved to the first position, and the driven gear engages with the second transmission mechanism of the second working device when the rocker arm is moved to the second position.

8. The multi-function peripheral of claim 7, wherein the power output device is a driving motor.

9. The multi-function peripheral of claim 7, wherein the power output device has an output shaft which couples with a main gear, the main gear being engaged with the driven gear.

10. The multi-function peripheral of claim 7, wherein the first working device is a paper feeding device, the first movement mechanism is a paper feeding barrel, and the first transmission mechanism is a gear set.

11. The multi-function peripheral of claim 1, wherein the second working device is a scanning operation device, the second movement mechanism is charge-coupled device, and the second transmission mechanism is a transmission belt and a gear set.
